(19) United States
(12) Patent Application Publication
(10) Pub. No.: US 2010/0125881 A1
(43) Pub. Date: May 20, 2010

(54) Method and apparatus for conveying content acquisition opportunities upon detection of proximity to interactive signage

(75) Inventors: Peter J. Douma, Wyckoff, NJ (US); Karen S. Holm, Montvale, NJ (US)

Correspondence Address: RADER FISHMAN & GRAUER PLLC, LION BUILDING, 1233 20TH STREET N.W., SUITE 501, WASHINGTON, DC, 20036, US

(73) Assignees: Sony Corporation, Tokyo (JP); Sony Corporation of America, New York, NY (US)

(21) Appl. No.: 12/292,311

(22) Filed: Nov. 17, 2008

(51) Int. Cl. H04N 7/173

(52) U.S. Cl. 725/87

(57) ABSTRACT

Automatically conveying content acquisition opportunities to users following detection of proximity to interactive signage. This may entail detecting proximity of a portable device to an interactive sign. The interactive sign is associated with a content item, such as music or a video that may be playing on or with the interactive sign. The portable device is associated with a user and has a user identifier. A unique identifier is generated in association with the proximity detection, which correlates the user identifier and the content item. The unique identifier is transmitted to a content site, which has some form of identification of both the user identifier as well as the corresponding content item. The content site then conveys to a device separate from the portable device an opportunity for the user to acquire a digital representation of the content item.

### BACKGROUND OF THE INVENTION

1. Field of the Invention

This invention relates generally to delivering preferred content to users and more particularly to automatically conveying content acquisition opportunities to users following detection of proximity with interactive signage.

2. Description of the Related Art

It is known to equip portable devices with technology that allows an identifier therein to be automatically identified through a wireless connection between the portable device and some other device.

For example, portable IC cards may implement radio frequency identification (RFID) so that the card may be read and identified by a card reader when the card is brought sufficiently proximate to the reader. Such portable cards may be active, passive or semi-passive. Active cards contain an internal power supply sufficient to both power the internal functionality of the card and to transmit signals to the reader. Passive cards do not contain a power supply, but instead rely upon energy provided by the card reader or some other external source to function. Semi-passive cards are a hybrid, typically containing a small battery that provides enough power for the internal functionality, with additional energy being provided externally to accommodate transmitting signals to the card reader.

A variety of wireless communication technologies may also be used to exchange data between the card and the reader. For example, Near Field Communication (NFC) is a short-range high frequency wireless communication technology which enables the exchange of data between devices over about a 10 centimeter distance. A variety of encoding techniques may also be used to encrypt the data communicated between the card and the reader.

It is also known to provide some form of activity corresponding to the detection of the portable device identifier. For example, one type of portable IC card used in an automobile may be automatically detected in conjunction with the payment of a toll. Other portable IC cards are often used in mass transit, wherein the fare for using the mass transit is automatically determined and paid by placing the portable card in proximity with card readers known to be at particular locations in the mass transit system.

The portable IC card may also contain a memory that may be variously updated to reflect gathered information and the like. It is believed that portable IC cards could be useful in allowing users to flag information that they are exposed to in various public places, so that they could subsequently engage in activity related to the flagged information. In this regard, a personal computer could be equipped with a portable IC card “port” that allows the personal computer to automatically interface with the portable IC card. Thus information gathered by the portable IC card could be automatically ported to the personal computer, which in turn may have a broadband Internet connection that would allow the user to shop or otherwise engage activity related to the flagged information.

However, there are situations where a great number of users may have a portable IC card with the above-described capabilities, but where those users do not have a personal computer configured with a port to allow them to automatically interface to the portable IC card. Thus, users are unable to take full advantage of the portability and information acquisition capabilities of portable IC cards. Additionally, even in situations where the user has the ability to port the portable IC card to the personal computer, there is still a need to take the extra steps of mating the two devices in order to take advantage of the portability of the portable IC card.

What is needed are techniques and corresponding systems and processes that allow users to automatically take advantage of portable IC card capabilities, even in situations where the users do not have portable IC card porting capability in some of their other devices.

### SUMMARY OF THE INVENTION

At least one embodiment of the present invention accommodates automatically conveying content acquisition opportunities to users following detection of proximity to interactive signage.

According to one aspect, this may entail detecting proximity of a portable device to an interactive sign. The interactive sign is associated with a content item, such as music or a video that may be playing on the apparatus of the interactive sign.

The portable device is associated with a user and has a user identifier (which may in some embodiments be the portable device identifier, which acts as a proxy for identifying the user). A unique identifier is generated in association with detecting the proximity between the interactive sign and the portable device. This unique identifier correlates the user identifier and the content item, and is transmitted to a content site, either through an intermediary site that manages the detection of such proximity events, or directly.

The content site, having received the unique identifier, has some form of identification of both the user as well as the corresponding content item. The content site then conveys to a device separate from the portable device an opportunity for the user to acquire a digital representation of the content item. This information may be actively or passively pushed to the user, or the content may be indicated based upon the user actively seeking the information.

According to another aspect, a user may also provide supplemental information separate from the proximity detection of the portable device to the interactive sign. This supplemental information may identify particular conditions regarding the opportunity to acquire the digital representation of the content item. Thus, for example, a user may separately indicate a preferred online music site, a preferred format, a preferred social networking site, etc. in conjunction with whatever content acquisition opportunities arise upon detection of the proximity of the portable device to the interactive sign.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1A is a schematic diagram illustrating a system wherein conveying content acquisition opportunities is provided.

FIG. 1B is a schematic diagram illustrating another system wherein conveying content acquisition opportunities is provided.

FIG. 2A is a block diagram illustrating an example of an interactive sign platform that accommodates automatically delivering content opportunities to users.

FIG. 2B is a block diagram illustrating another example of an interactive sign platform that further accommodates automatically delivering content opportunities to users with received supplemental information.

FIG. 3 is a flow diagram illustrating an example of detecting proximity and initiating a content opportunity.

FIG. 4 is a block diagram illustrating an example of a content site management server configured to automatically convey available content items.

FIG. 5 is a flow diagram illustrating an example of receiving an indication of a proximity event and conveying a content acquisition opportunity.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

At least one embodiment of the present invention accommodates automatically conveying content acquisition opportunities to users following detection of proximity to interactive signage.

According to one aspect, this may entail detecting proximity of a portable device to an interactive sign. The interactive sign is associated with a content item, such as music or a video that may be playing on the apparatus of the interactive sign.

The portable device is associated with a user and has a user identifier. A unique identifier is generated in association with detecting the proximity between the interactive sign and the portable device. This unique identifier correlates the portable device identifier and the content item, and is transmitted to a content site, either through an intermediary site that manages the detection of such proximity events, or directly.

The content site, having received the unique identifier, has some form of identification of both the portable device (which may be considered a proxy for identifying the user) as well as the corresponding content item. The content site then conveys to a device separate from the portable device an opportunity for the user to acquire a digital representation of the content item. This information may be actively or passively pushed to the user, or the content may be indicated based upon the user actively seeking the information.

According to another aspect, a user may also provide supplemental information separate from the proximity detection of the portable device to the interactive sign. This supplemental information may identify particular conditions regarding the opportunity to acquire the digital representation of the content item. Thus, for example, a user may separately indicate a preferred online music site, a preferred format, a preferred social networking site, etc. in conjunction with whatever content acquisition opportunities arise upon detection of the proximity of the portable device to the interactive sign.

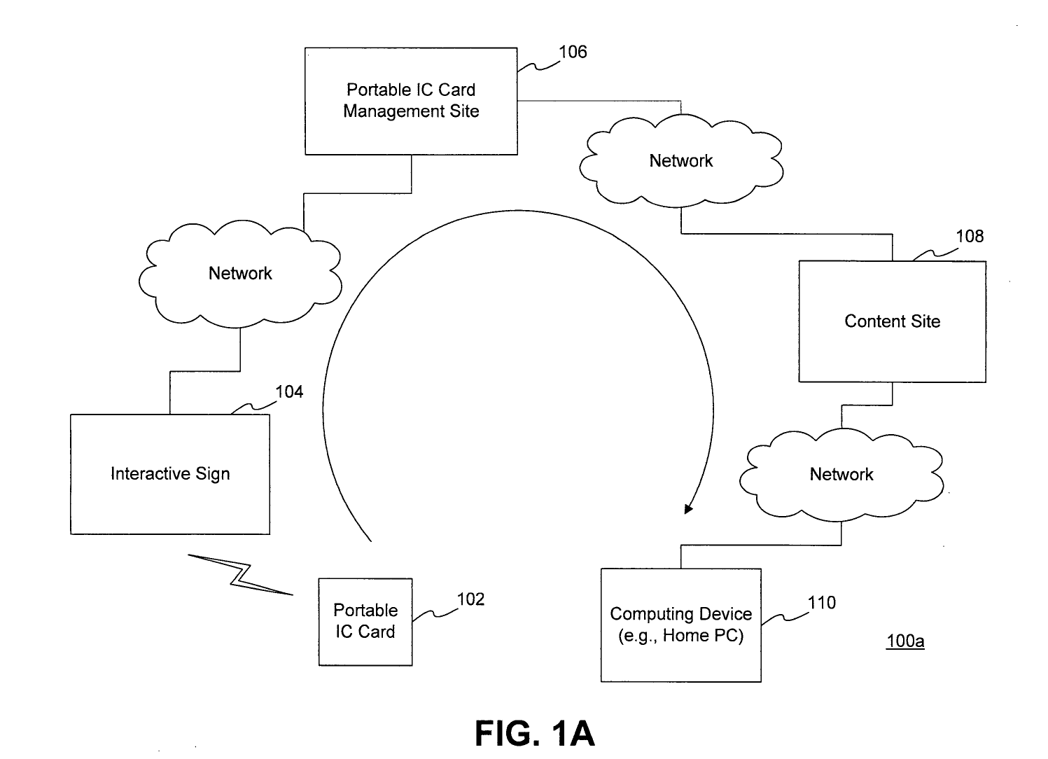

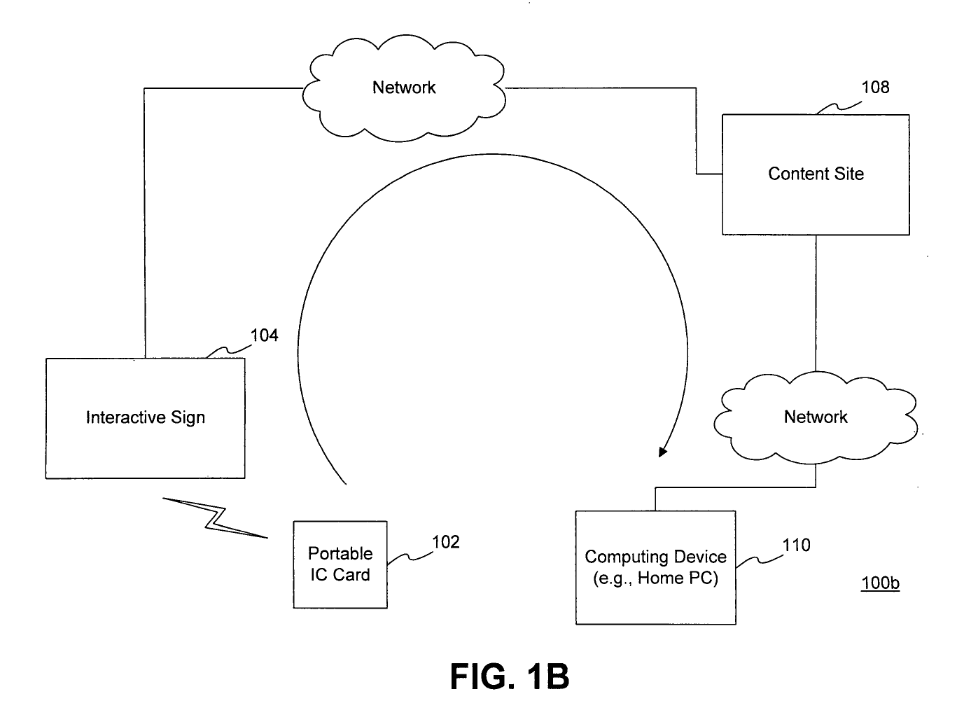

FIG. 1A is a schematic diagram illustrating a system 100 wherein conveying content acquisition opportunities is provided.

The system 100 comprises a portable IC card 102, an interactive sign 104, a portable IC card management site 106, a content site 108, and a computing device 110 such as a home personal computer.

The interactive sign 104, portable IC card management site 106, content site 108, and computing device 110 respectively include computing architecture and corresponding software that accommodate network communications between the various devices, as well as the functionality of conveying content acquisition opportunities, as illustrated and described herein.

By way of example, the interactive sign 104 may be connected to a local network that is in turn connected to the portable IC card management site 106 through either a public or private network including by not necessarily limited to an Internet connection. Similarly, the portable IC card management site 106 may communicate with the content site 108 through a public or private network, and the content site 108 may communicate with the personal computer similarly, as is well known.

It is also noted that the term site is used for ease of illustration and discussion. It should be readily recognized that the corresponding functionality may actually be provided by multiple servers.

Still referring to FIG. 1A, the interactive sign 104 may be present in any place where it may be confronted with user traffic. For example, the interactive sign 104 may be placed in a shopping mall, a train station, gas station, public walkway, private golf club, or any location deemed appropriate.

The interactive sign 104 is also preferably configured to include multimedia capabilities so that it can play content such as music or videos that might be currently available. Alternatively, the interactive sign 104 may augment other devices that play multimedia content by providing an associated display that might merely indicate the availability of a content acquisition opportunity. The interactive sign 104 is also equipped with the ability to detect the proximity of portable IC cards, and thus includes a card reader and related functionality.

The portable IC card 102 preferably includes technology that allows a portable card identifier to be detected automatically through a short range wireless connection. One example of a portable IC card 102 is FELICA™ as provided by Sony Corporation, Tokyo, Japan. FELICA™ is a contactless IC card that includes a platform that may be configured to provide corresponding services. The contactless communication between a reader/writer and the card is activated by electromagnetic waves radiated from the reader/writer antenna, compliant with ISO/IEC 18092. The portable IC card 102 preferably includes an IC chip that contains enough memory to store data, and processing capability to provide the basic wireless functions, encryption and authentication, and the related functions described herein. Although FELICA™ is described as a preferred example of the portable IC card 102, this embodiment is not so-limited, as any portable IC card 102 capable of storing information and being detected in proximity with the interactive sign 104 may be provided.

The portable IC card 102 may be credit-card sized and held in a person's wallet, pocket purse or the like as they are driving or walking about. An initiation of the process of initiating a content acquisition opportunity may commence when the user swipes or otherwise brings the portable IC card 102 within sufficient proximity to the interactive sign 104. The proximity required for this may vary. In the example of NFC technology, this may be approximately 10 cm. Other examples may allow for detection at longer ranges.

The swiping of the portable IC card 102 may be undertaken in conjunction with music or a video currently being played by or around the interactive sign 104. Additionally, the content that is playing may not exactly match the content available for acquisition, and this may be made known by communicating it to the user, or inherently understood. For example, a video may be playing for a particular song, but it may be displayed or understood that the corresponding content for acquisition is music (audio only). Alternatively, a trailer may be shown for a movie, with it being understood that the movie itself, and not the trailer, is available for acquisition.

The interactive sign 104 receives the portable device identifier corresponding to the portable IC card 102 as a result of the swiping activity, and also has an identification of the particular content item currently available for acquisition. The latter information may be readily known at the interactive sign 104 in the situation where it is playing the corresponding content item (or related content). Alternatively, an identification of the current content item may be separately communicated to the interactive sign 104. A user identifier specific to the content acquisition technique may be wirelessly communicated to the interactive sign 104, as the user identifier. Alternatively, the portable device identifier operates as a proxy for identifying the user, for subsequent determination where to send the content acquisition opportunity, as described further below.

The interactive sign 104 takes this information and generates a unique identifier that correlates the user identifier and the particular content item. For example, this may be in the form of a token or a string of information that contains both pieces of information, as well as any other information useful for communicating with the portable IC card management site 106. The interactive sign 104 generates this unique identifier and then sends the unique identifier to the portable IC card management site 106, such as via a conventional network communication.

The portable IC card management site 106 contains information identifying various registered users and thus automatically identifies the user based upon the user identifier. For the purposes of content acquisition, the user may designate any identifier capable of being communicated by the portable IC card 102 as the “user identifier”. Additionally, the portable IC card management site 106 is able to determine a content site 108 that should be contacted in association with the particular content item in any given request from the interactive sign. In simple cases, this may be in the form of the only content site that the portable IC card management site 106 is associated with, or a default content site corresponding to the user (e.g., during registration the user may indicate the preferred content site). Alternatively, the portable IC card management site 106 may have a table mapping content items to one of several potentially appropriate content sites. Still further, the portable IC card management site 106 may maintain a database of information corresponding to any given user, with fields for content sites and corresponding preferences. Queries to this database can be used to determine the most appropriate content site.

Once the content site is determined, the portable IC card management site 106 communicates the identification of the user and the corresponding content item to the content site 108 via a network communication. This may merely be a pass through communication of the unique identifier (e.g., string of information) originally sent by the interactive sign 104 to the IC card management site 106 or may be separately configured information. For example, the user ID for the content site 108 may differ from that used by the portable IC card management site 106, so it may be translated accordingly.

Once provided with this information, the content site 108 may then convey to a device separate from the portable IC card an opportunity for the user to acquire a digital representation of the content item. In one example, this device may be the home personal computer of the user. However, the content site 108 does not necessarily actively send a message to the user. Rather, and possibly more likely, the content site 108 makes the availability of the content item known to the user the next time the user accesses the content site. The user may have local software on the computing device 108 that plays and organizes music and/or other types of content. However, certain information provided in the local user interface is populated by information provided from the content site 108. Thus, a folder may indicate content that is suggested for availability based upon the process described herein. This folder may be appropriately named such as “Available for Download” and may contain one or more content items based upon various events wherein the user's portable IC card 102 is placed proximate appropriate interactive signs 104. Selecting a content item may be used to confirm that the user would like to download the representation of the content item. Alternatively, acquisition of streaming content may be similarly initiated.

It should be noted that the items made available may not necessarily be limited to downloaded or streamed content. For example, the interactive sign 104 may display an advertisement for a consumer electronics device, and swiping the portable IC card 102 may thus initiate an opportunity to purchase the consumer electronics device using an online service provider. Alternatively, the interactive sign 104 may display an advertisement for dining at a particular restaurant, and swiping the portable IC card 102 may thus initiation an opportunity to receive a coupon or token for a discount or free item at the particular restaurant.

By way of example, the content site 108 may be ITUNES™ as provided by Apple Computer, Cupertino, Calif., or SONYSTYLE™, as provided by Sony Corporation, Tokyo, Calif., AMAZON™, or any of various other content sites.

In addition to the mode of operation wherein the user swipes the portable IC card 102 to send an identification of the user and the content to an appropriate site, as an alternative the user may also provide supplemental information separate from the proximity detection of the portable IC card to the interactive sign. This supplemental information may identify particular conditions regarding the opportunity to acquire the digital representation of the content item. Thus, for example, a user may separately indicate a preferred online music site, a preferred format, a preferred social networking site, etc. in conjunction with whatever content acquisition opportunities arise upon detection of the proximity of the portable device to the interactive sign. This may be undertaken by having the interactive sign 104 configured to include inputs for providing such information, or the portable IC card 102 may be configured to provide additional data in conjunction with proximity detection.

FIG. 1B is a schematic diagram illustrating another system 100b wherein conveying content acquisition opportunities is provided. In this example, the portable IC card management site 106 is omitted. Instead, the unique identifier is directly sent from the interactive sign 104 to the content site 108, and the content site recognizes the identified user and the corresponding content, and conveys the availability of the content to the user in the same fashion as described above.

In conjunction with managing a portable IC card 102 and the corresponding conveyance of content for acquisition, it is noted that the user's computing device 110 may be equipped with software that allows management of both the portable IC card 102 and the process of acquiring content. In this regard, the user may register with the portable IC card management site 106 using conventional techniques, and may variously indicate preferences for receiving content, including identification of desired content sites, formats, etc. The functionality of generating content acquisition opportunities may also be extended to a network of other users in this fashion. Thus, when a user sees desirable content, bringing the portable IC card 102 into proximity of the interactive sign 104 may prompt not only the generation of an opportunity to acquire the content for the user, but also for a defined network or other users. Additionally, this functionality may be linked to a social networking site that allows the network of users to be variously defined accordingly.

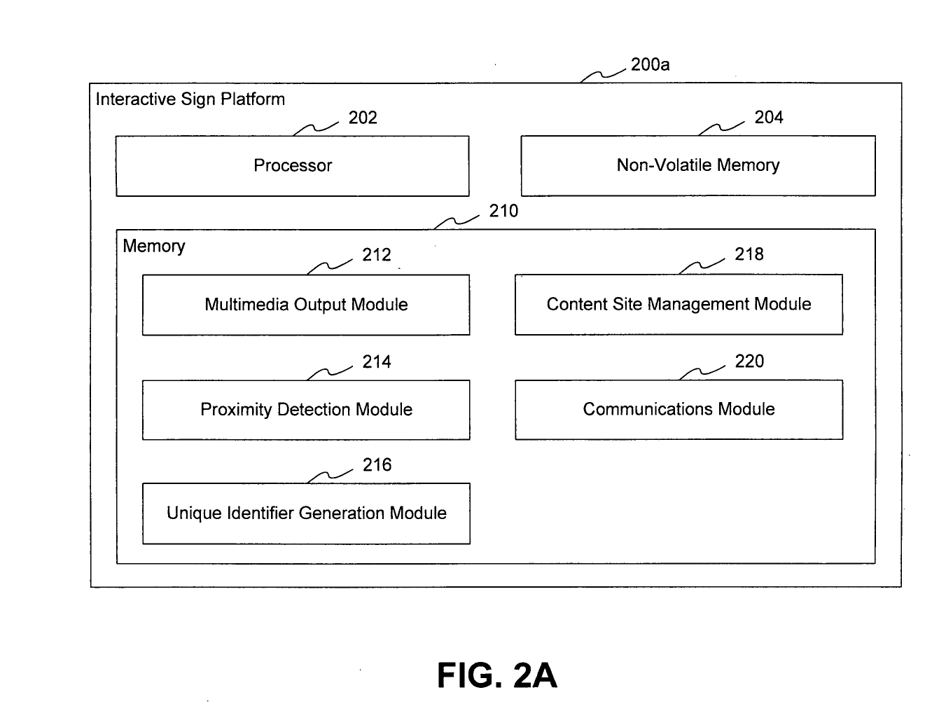

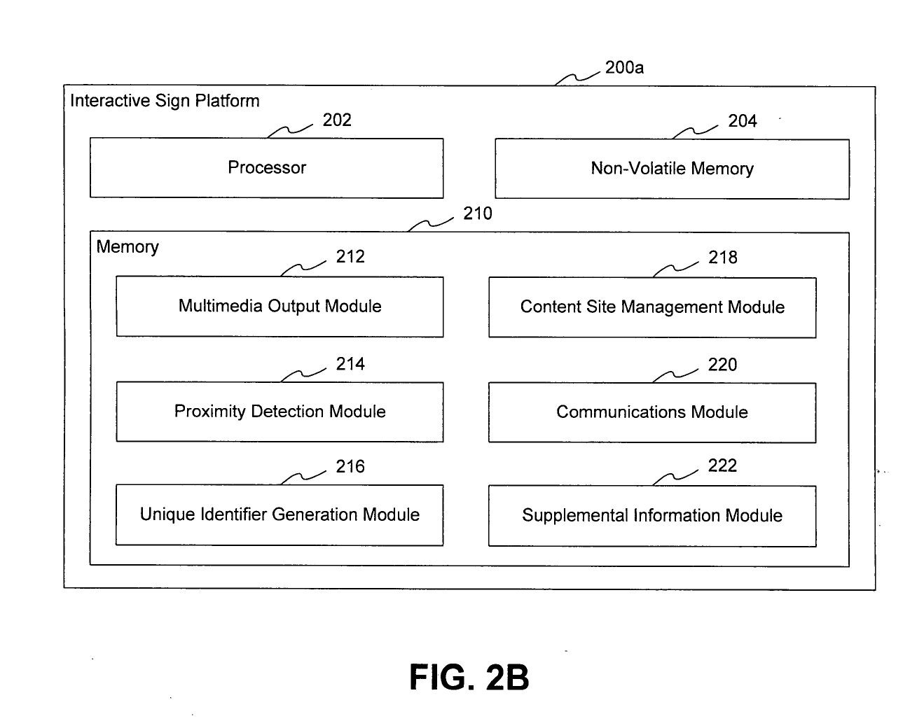

FIG. 2A is a block diagram illustrating an example of an interactive sign platform 200a that accommodates automatically delivering content opportunities to users. The interactive sign platform 200a preferably includes computing architecture and corresponding software to carry out the functionality described herein and further below. As an alternative to software, circuitry, firmware, or combinations of circuitry, firmware may be used to carry out the described functionality. Although one modular breakdown is described, it is noted that the same functionality may be carried out using fewer, greater, or differently named modules.

The interactive sign platform 200a comprises a processor 202, non-volatile memory 204, and memory 210 that shows resident multimedia output module 212, proximity detection module 214, unique identifier generation module 216, content site management module 218 and communications module 220.

The processor 202 may be any conventional processor for executing instructions stored in memory 210. The non-volatile memory 204 may be a hard disk, flash memory, or other memory. It preferably includes basic instructions for booting up the interactive sign platform 200a and may also be variously updated when the functionality of the sign is updated, such as to include new content opportunities, new content sites, and new user types (e.g., types of devices, groups of users, etc.).

The communications module 220 facilitates and manages communications with the various other devices using conventional network communications, wireless communications, and the like as described.

The multimedia output module 212 determines and controls the currently output content corresponding to available content items. It may include a display and/or audio outputs as previously described.

The proximity detection module 214 detects the proximity of portable IC cards to the location of the interactive sign. This may be accommodated by communicating with an IC card reader of the interactive sign. In conjunction with detected proximity, a user identifier is acquired, which may be the portable IC card identifier acting as a proxy for identification of the user, or a separate specifically created and determined user identifier that is communicated to the proximity detection module 214 in conjunction with a proximity detection event.

The proximity detection module 214 is in communication with the unique identifier generation module 216 which receives the user identifier and also retrieves a content identifier corresponding to the content item that is currently associated with the interactive sign at the time that the proximity of the portable IC card is detected.

The content site management module 218 manages the verification of content sites that correspond to the interactive sign and manages communications with the appropriate content site(s) in connection with the conveyance of content opportunities to users in connection with detected proximity events. The unique identifier generation module 216 is in communication with the content site management module 218 and they cooperate to prepare a coherent communication with the appropriate content site. The unique identifier that is generated may comprise the user identifier and corresponding content identifier for the currently associated content item. The content site management module 218 may engage in a communication session with the content site, and send both of these identifiers to the content site. Any number of techniques may be used, including but not limited to preparation of a token containing both the user identifier and content identifier and sending the same to the relevant content site(s). This information is communicated to the content site, which in turn conveys to a device separate from the portable IC card of the user an opportunity for the user to acquire a digital representation of a content item (e.g., music download or music stream, or similarly a video download or stream). Alternatively, an opportunity to purchase other content items such as consumer electronics associated to whatever is displayed on the interactive sign may be provided. Still further, as noted opportunities to acquire coupons or passes at local restaurants or events may be provided. Each of these may be conveyed as an acquisition opportunity to the user at the separate location and delivered to the user in digital form (e.g., download digital information, and then printing the coupon at home, or downloading a digital version of music, etc.).

FIG. 2B is a block diagram illustrating another example of an interactive sign platform 200b that further accommodates automatically delivering content opportunities to users with received supplemental information. The interactive sign platform 200b is identical to the previously described platform, with the exception being that it also includes a supplemental information module 222. The supplemental information module 222 operates to receive supplemental information separate from detecting the proximity of the portable device to the interactive sign. Thus, the interactive sign platform 200b may collect more than just the user identifier upon a proximity detection event. For example, the portable IC card may be equipped with enough memory space and programmable capability to allow a user to associate additional, more detailed information with the portable IC card.

Alternatively, the interactive sign may include a capability of allowing a user to separately convey information, such as through dedicated input buttons, conventional information entry devices, voice commands, and the like.

With the supplemental information, in addition to associating the content item to the user identifier, the interactive sign platform 200b may identify particular conditions regarding the opportunity to acquire the digital representation of a content item. This may include the user's identification of a preferred content site, a preferred format for digital content, a preferred destination device for the content opportunity, an identification of a social network site and/or a group of individuals with whom the user would like to share the content acquisition opportunity, or other information.

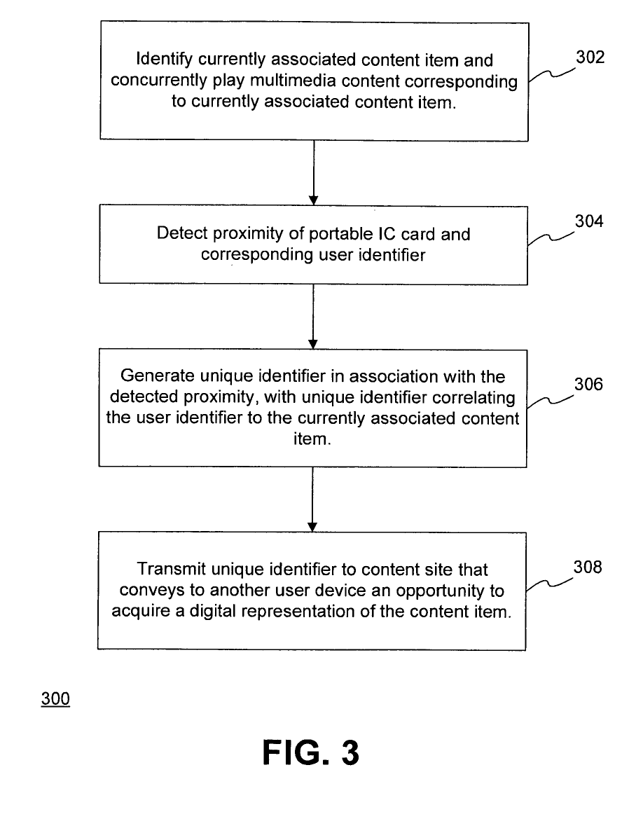

FIG. 3 is a flow diagram illustrating an example of detecting proximity and initiating a content opportunity 300. An initial preparation entails identifying 302 a content item that is currently associated to the interactive sign. In some applications, this may be performed independently from whatever is shown on the interactive sign, but preferably there is an association between what is shown/heard and the currently available content item. As explained previously, this may entail displaying a video, music, or the like corresponding to the current content item by the interactive sign.

Any number of users may approach the interactive sign, which detects 304 the proximity of the portable IC card and retrieves the corresponding user identifier as described. Once this is done, the unique identifier is generated 306 in association with the detected proximity. The unique identifier correlates the user with the content item and preferably incorporates the user identifier and a relevant content identifier to further communication with the content site.

The unique identifier is then transmitted 308 to the content site, which in turn conveys to another user device the opportunity to acquire the content item, preferably but not necessarily a digital representation of the content item.

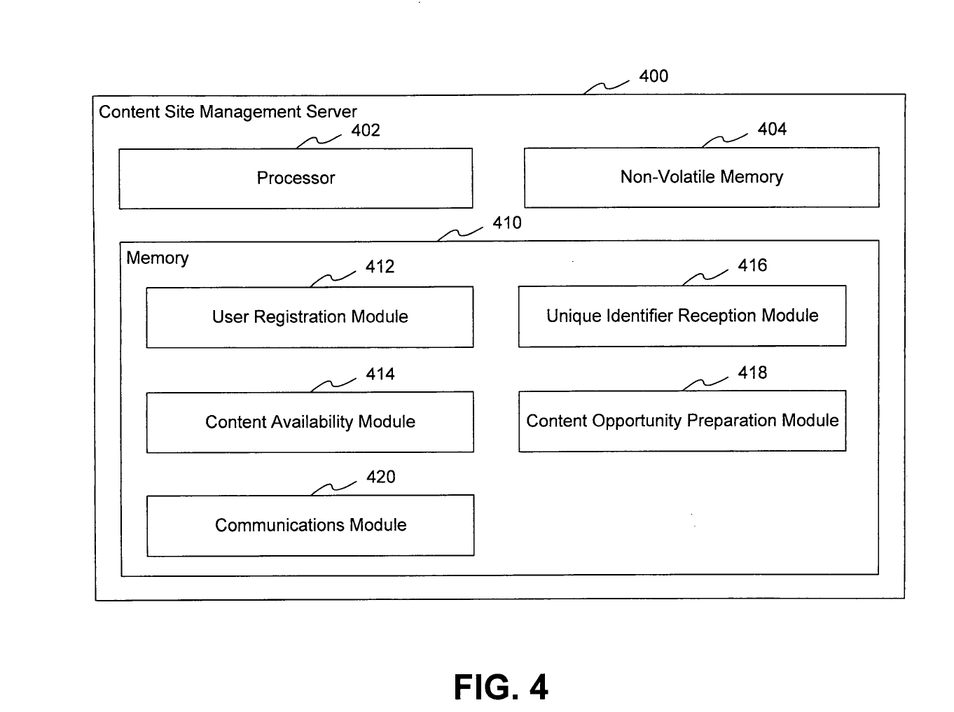

FIG. 4 is a block diagram illustrating an example of a content site management server 400 configured to automatically convey available content items. The content site management server 400 includes conventional computing architecture with a corresponding memory 410 and processor 402 for executing instructions stored therein. The server 400 may include resident non-volatile memory 404 and will also communicate with external sources of data which need not be shown for an understanding of this embodiment. Although one modular breakdown of the functions provided by the content site management server 400 is described, it is noted that the same functionality may be provided by fewer, greater, or differently named modules.

The server 400 includes a user registration module 412, a content availability module 414, a unique identifier reception module 416, a content opportunity preparation module 418 and a communications module 420.

The communications module 420 facilitates communications, such as conventional network communications with other devices such as the interactive sign and user devices that are to be the vehicles through which content acquisition opportunities are provided.

The user registration module 412 allows the content site to verify appropriate users and provide corresponding services. It may employ registration procedures wherein the user provides account information and is given login credentials to access the content site. Various (e.g., cookie) technology may also be used to automatically recognize a user device that has previously interacted with the content site. The content site may also maintain information that is pushed to the user so that when the user logs onto their account, they are made aware of information.

The content availability module 414 manages associated content database(s) to ensure that whatever is conveyed as available from the content site is indeed available, both in terms of content titles but also whatever formats or other parameters are desired in association with the user's access of the content site.

The unique identifier reception module 416 communicates with the interactive sign platform and thus may receive any number of unique identifiers that are associated with proximity detection events management by the interactive sign platform. The unique identifier reception module 416 may use various techniques for both identifying a user and corresponding content item in connection with such a communications, including but not limited accessing an information string containing both pieces of information and parsing the string to extract the user identifier and the content identifier.

The content opportunity preparation module 418 receives the request and the corresponding user identifier and content identifier, and conveys the opportunity to acquire the content to the registered user. This may entail communications with the registration module 412 to confirm registration of the user based upon the user identifier, and then accessing the user account to provide an update wherein the content item is indicated as available. This information may be passively retained in association with the user's account so that, for example, the next time they log onto the account they will be presented with an interface that allows them to carry out the acquisition of the content item. This may be in the form of a folder that indicates the available items (e.g., “items available for download”, etc.). Alternatively, an active message may be used to prompt user acquisition, such as an e-mail with a link that accommodates acquiring the content item. Additionally, as described above, in one alternative the user may provide supplemental information that causes a group of individuals to be presented with content acquisition opportunities. This may entail communications with those users in various ways, which may include updating their account information to indicate the acquisition opportunity in the same fashion as was done for the user. Appended information may indicate the source of the content item (e.g., “your friend [name] recommended [content title] when she was at [location of interactive sign]”).

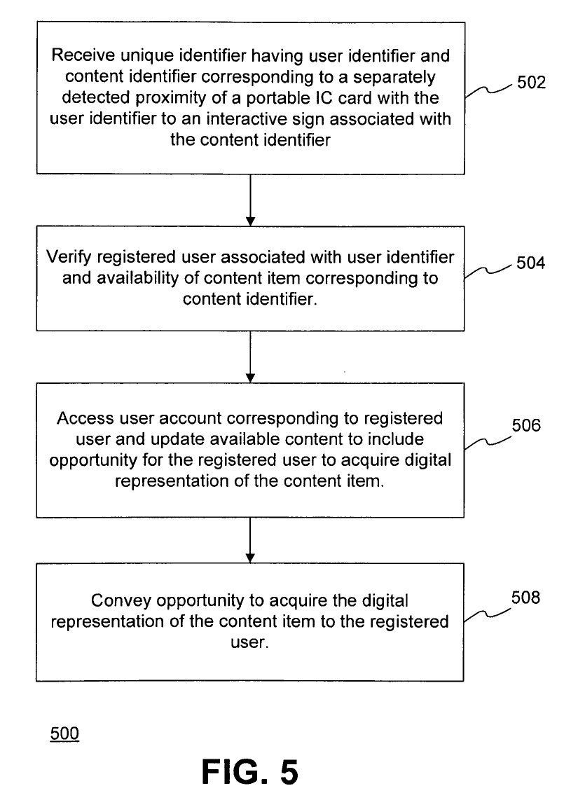

FIG. 5 is a flow diagram illustrating an example of receiving an indication of a proximity event and conveying a content acquisition opportunity 500. As described in further detail above, this may entail receiving 502 a unique identifier that has an associated user identifier and content identifier, with the unique identifier corresponding to a separately detected proximity of a portable IC card with the user identifier by an interactive sign that at the time of proximity detection is associated with a content item having the content identifier. Verification 504 of the registered user associated with user identifier and the availability of content item corresponding to content identifier is then undertaken. If these verifications pass, then the user account is accessed 506 for the registered user and the available content in the account is updated to include an opportunity for the registered user to acquire (e.g., a digital representation of) the content item. The opportunity to acquire the content item is then conveyed 508 to the registered user in the fashion further described previously.

Initiating and receiving content opportunities entails various physical transformation of memories and displays as described herein. When the user reviews and seeks to realize the content acquisition opportunity, further physical transformation is provided. For example, realizing the content acquisition opportunity may be variously fulfilled as described herein, including but not limited to (1) downloading or streaming music, storing the music on a non-volatile memory, and then playing the music as desired; (2) downloading video in the same fashion; or (3) downloading digital content that may then be printed to provide a document that can be used in a retail environment, at an event, etc.; etc.

Thus embodiments of the present invention produce and provide automatically conveying content acquisition opportunities. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A computer-implemented method for automatically delivering preferred content opportunities to users following wireless identification of the user in association with interactive signage, the method comprising:
detecting a proximity of a portable device to an interactive sign, the interactive sign being associated with a content item, the portable device being associated with a user and having a user identifier;
generating a unique identifier in association with detecting the proximity between the interactive sign and the portable device, the unique identifier correlating the user identifier and the content item; and
transmitting the unique identifier to a content site that conveys to a device separate from the portable device an opportunity for the user to acquire a digital representation of the content item.

2. The method according to claim 1, further comprising:
receiving supplemental information separate from detecting the proximity of the portable device to the interactive sign, the supplemental information being received based upon a user selection and identifying particular conditions regarding the opportunity to acquire the digital representation of the content item.

3. The method according to claim 1, wherein the portable device is an IC card including an RFID tag.

4. The method according to claim 1, wherein the content item comprises music and the digital representation of the content item comprises at least one of a downloaded copy of the content item or a streamed copy of the content item.

5. The method according to claim 1, wherein the content item comprises video and the digital representation of the content item comprises at least one of a downloaded copy of the video or a streamed copy of the video.

6. The method according to claim 1, wherein the interactive sign is part of an apparatus that outputs at least one of audio and video for the content item concurrently with detecting the proximity of the portable device.

7. The method according to claim 1, wherein the user identifier is a portable device identifier of the portable device.

8. A system for automatically delivering preferred content opportunities to users following wireless identification of the user in association with interactive signage, the system comprising:
means for detecting a proximity of a portable device to an interactive sign, the interactive sign being associated with a content item, the portable device being associated with a user and having a user identifier;
means for generating a unique identifier in association with detecting the proximity between the interactive sign and the portable device, the unique identifier correlating the user identifier and the content item; and
means for transmitting the unique identifier to a content site that conveys to a device separate from the portable device an opportunity for the user to acquire a digital representation of the content item.

9. The system according to claim 8, further comprising:
means for receiving supplemental information separate from detecting the proximity of the portable device to the interactive sign, the supplemental information being received based upon a user selection and identifying particular conditions regarding the opportunity to acquire the digital representation of the content item.

10. The system according to claim 8, wherein the portable device is an IC card including an RFID tag.

11. The system according to claim 8, wherein the content item comprises music and the digital representation of the content item comprises at least one of a downloaded copy of the content item or a streamed copy of the content item.

12. The system according to claim 8, wherein the content item comprises video and the digital representation of the content item comprises at least one of a downloaded copy of the video or a streamed copy of the video.

13. The system according to claim 8, wherein the interactive sign is part of an apparatus that outputs at least one of audio and video for the content item concurrently with detecting the proximity of the portable device.

14. The system according to claim 8, wherein the user identifier is a portable device identifier of the portable device.

15. An apparatus for automatically delivering preferred content opportunities to users following wireless identification of the user in association with interactive signage, the apparatus comprising:
a proximity detection module, which detects a proximity of a portable device to an interactive sign, the interactive sign being associated with a content item, the portable device being associated with a user and having a user identifier;
a unique identifier generation module, which generates a unique identifier in association with detecting the proximity between the interactive sign and the portable device, the unique identifier correlating the user identifier and the content item; and
a communications module, which transmits the unique identifier to a content site that conveys to a device separate from the portable device an opportunity for the user to acquire a digital representation of the content item.

16. The apparatus according to claim 15, further comprising:
a supplemental information module, which receives supplemental information separate from detecting the proximity of the portable device to the interactive sign, the supplemental information being received based upon a user selection and identifying particular conditions regarding the opportunity to acquire the digital representation of the content item.

17. The apparatus according to claim 15, wherein the portable device is an IC card including an RFID tag.

18. The apparatus according to claim 15, wherein the content item comprises music and the digital representation of the content item comprises at least one of a downloaded copy of the content item or a streamed copy of the content item.

19. The apparatus according to claim 15, wherein the content item comprises video and the digital representation of the content item comprises at least one of a downloaded copy of the video or a streamed copy of the video.

20. The apparatus according to claim 15, wherein the interactive sign is part of an apparatus that outputs at least one of audio and video for the content item concurrently with detecting the proximity of the portable device.

21. The apparatus according to claim 15, wherein the user identifier is a portable device identifier of the portable device.

22. A method for automatically delivering preferred content opportunities to users following wireless identification of the user in association with interactive signage, the method comprising:
receiving a unique identifier that includes a user identifier and a content identifier corresponding to a separately detected proximity of a portable device to an interactive sign, the interactive sign being associated with a content item identified by the content identifier, the portable device having the user identifier;
verifying a user associated with the user identifier and an availability of a digital representation of the content item in association receiving the unique identifier; and
conveying to a device separate from the portable device an opportunity for the user to acquire the digital representation of the content item.

23. A system for automatically delivering preferred content opportunities to users following wireless identification of the user in association with interactive signage, the method comprising:
means for receiving a unique identifier that includes a user identifier and a content identifier corresponding to a separately detected proximity of a portable device to an interactive sign, the interactive sign being associated with a content item identified by the content identifier, the portable device having the user identifier;
means for verifying a user associated with the user identifier and an availability of a digital representation of the content item in association receiving the unique identifier; and
means for conveying to a device separate from the portable device an opportunity for the user to acquire the digital representation of the content item.
